(19) United States
(12) Patent Application Publication
(10) Pub. No.: US 2010/0111372 A1
(43) Pub. Date: May 6, 2010

(54) DETERMINING USER SIMILARITIES BASED ON LOCATION HISTORIES

(75) Inventors: Yu Zheng, Beijing (CN); Xing Xie, Beijing (CN); Wei-Ying Ma, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/264,038

(22) Filed: Nov. 3, 2008

(51) Int. Cl. G06K 9/00; G08B 5/22

(52) U.S. Cl. 382/113; 340/825.49

(57) ABSTRACT

Method for determining similarities between a first user and a second user in a network, including receiving one or more Global Positioning System (GPS) logs from each user in the network, constructing a first hierarchal graph for the first user's GPS log and a second hierarchical graph for the second user's GPS log, and calculating a similarity score between the first user and the second user based on the first hierarchal graph and the second hierarchical graph.

### BACKGROUND

The increasing popularity of location-acquisition technologies, such as Global Positioning Systems (GPS) and Global System for Mobile communications (GSM) networks, etc, is leading to the collection of large spatio-temporal dataset of many individuals. This dataset provides the opportunity of discovering valuable knowledge about users' movement behaviors including basic information, such as distance, duration and velocity etc, of a particular route. This knowledge may be used to find similarities between users because people who have similar location histories might share similar interests and preferences. Therefore, the more location histories the users shared, the more correlated these users would be.

### SUMMARY

Described herein are implementations of various techniques for determining user similarities based on location histories. In one implementation, a computer application may receive a Global Positioning System (GPS) log from two or more users in a computing network. The computer application may map the latitude and longitude coordinate pairs listed in each of the GPS logs as a node on a map. While mapping the coordinate pairs on the map, the computer application may add directional arrows from one node to another to indicate the order in which each coordinate pair may have been visited by each user. The resulting map may indicate a GPS trajectory or a first location history for the user.

The computer application may then locate one or more stay points that may be on the first location history. In one implementation, the stay point may be a virtual location with latitude and longitude coordinates in the center of a group of nodes that may all be within a near distance of each other. The computer application may then group two or more stay points together to create clusters. Clusters may be defined as a geographical region encompassing multiple stay points densely located near each other. In one implementation, each cluster may contain two or more sub-clusters. Each subcluster may include two or more stay points that are within the cluster, but the stay points in the subcluster may be within a closer proximity of each other than the stay points within the cluster.

After determining the clusters and subclusters for all the users in the network, the computer application may create a hierarchal framework to represent all of the clusters and subclusters. The hierarchal framework may list all of the clusters and subclusters in a hierarchy of layers such that each higher layer on the hierarchy may describe a larger geographical region. Each subcluster may represent a layer in the framework underneath the layer in which its relative cluster may lay. From the hierarchal framework, the computer application may create a hierarchal graph for each user. The hierarchal graph may include one or more graphs that may indicate the clusters or subclusters in which the user may have traveled for each layer of the hierarchal framework.

Using the hierarchal graphs of two users, the computer application may determine the similarity between the two users by evaluating the locations that they both may have traveled. The computer application may factor in items, such as the popularity of locations visited by users, the similar order in which two users may have traveled to multiple locations, and the amount of time it may have taken each user to travel to the multiple locations when determining the similarity between two users.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a flow diagram of a method for creating a hierarchal graph to model one or more users' location histories in accordance with one or more implementations of various techniques described herein.

FIG. 3 illustrates a schematic diagram that represents the process for creating a hierarchal graph in accordance with one or more implementations of various techniques described herein.

FIG. 4 illustrates a flow diagram of a method for determining user similarities between two users based on location histories in accordance with one or more implementations of various techniques described herein.

### DETAILED DESCRIPTION

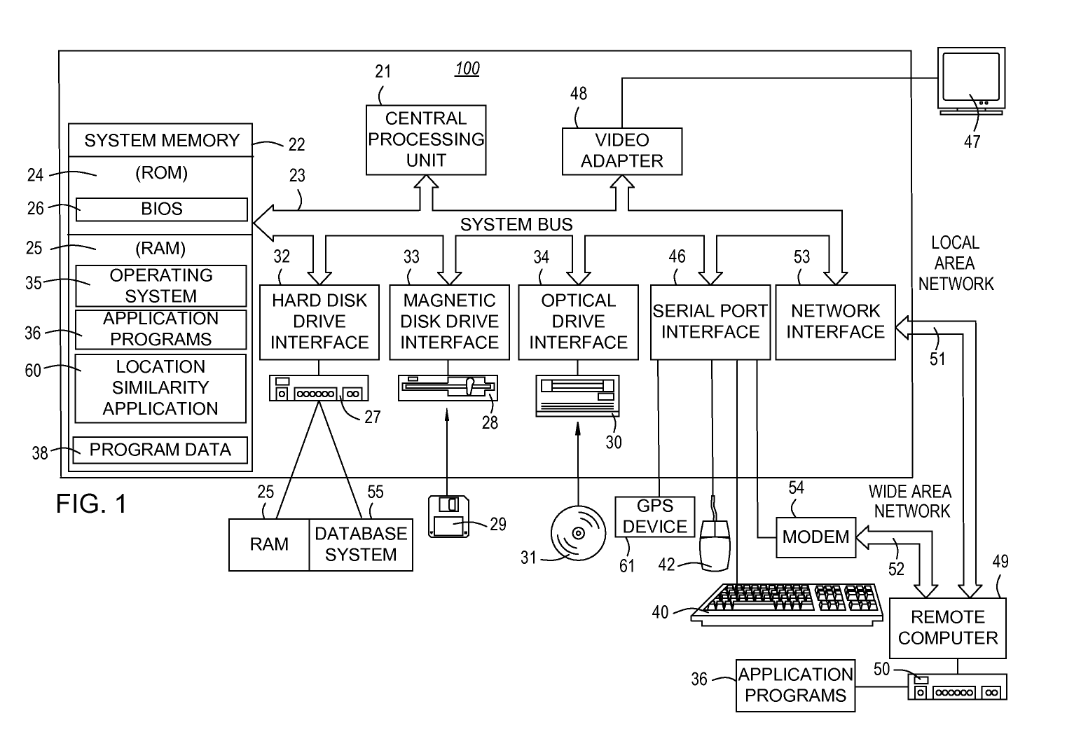

In general, one or more implementations described herein are directed to determining user similarities based on location histories. One or more implementations of various techniques for determining user similarities based on location histories will now be described in more detail with reference to FIGS. 1-4 in the following paragraphs.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

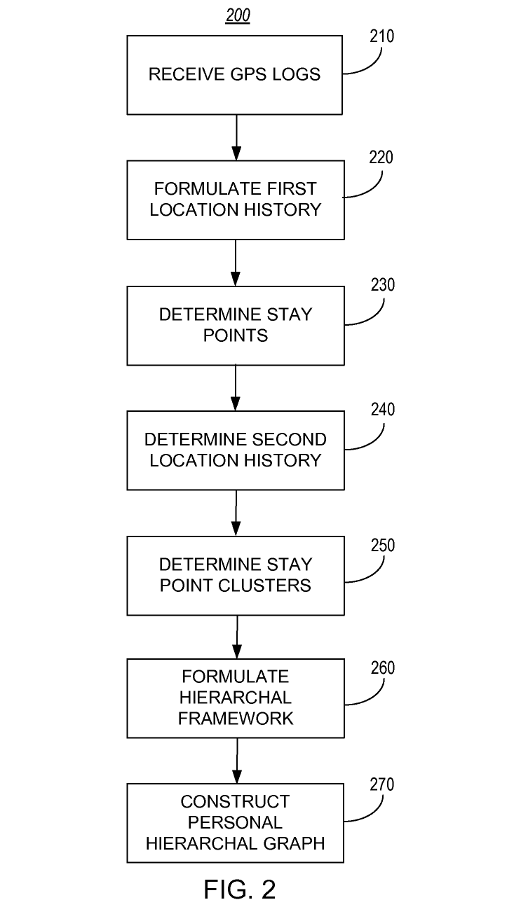

A number of program modules may be stored on the hard disk 27, magnetic disk 29, optical disk 31, ROM 24 or RAM 25, including an operating system 35, one or more application programs 36, a location similarity application 60, program data 38, and a database system 55. The operating system 35 may be any suitable operating system that may control the operation of a networked personal or server computer, such as Windows® XP, Mac OS® X, Unix-variants (e.g., Linux® and BSD®), and the like. The location similarity application 60 may be an application that may enable a user to determine the similarities of two or more users based on their location histories. The location similarity application 60 will be described in more detail with reference to FIGS. 2-4 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). The Global Positioning System (GPS) device 61 may be connected to the computing system 100 via the serial port interface 46. The GPS device 61 may include location data pertaining to the locations that a user may have traveled. The location data may be uploaded to the computing system 100 via the serial port interface and system bus 23 to the system memory 22 or the hard disk drive 27 for storage. A monitor 47 or other type of display device may also be connected to system bus 23 via an interface, such as a video adapter 48. In addition to the monitor 47, the computing system 100 may further include other peripheral output devices such as speakers and printers.

Further, the computing system 100 may operate in a networked environment using logical connections to one or more remote computers The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow diagram of a method 200 for creating a hierarchal graph to model one or more users' location histories in accordance with one or more implementations of various techniques described herein. The following description of method 200 is made with reference to computing system 100 of FIG. 1 in accordance with one or more implementations of various techniques described herein. Additionally, it should be understood that while the operational flow diagram indicates a particular order of execution of the operations, in some implementations, certain portions of the operations might be executed in a different order. In one implementation, the process for creating a hierarchal graph to model one or more users' location histories may be performed by the location similarity application 60.

At step 210, the location similarity application 60 may receive one or more GPS logs from two or more users in a computing network that may be stored on the GPS device 61, the system memory 22, the hard disk drive 27, or a similar memory storage device. The GPS logs may include GPS location information, such as a pair of latitude and longitude coordinates for each location visited by a user and a corresponding time stamp indicating when each coordinate pair was visited.

At step 220, the location similarity application 60 may formulate a GPS trajectory or a first location history from the GPS logs for two or more users. The first location history may describe the path in which a user may have traveled and include a display of a list of latitude and longitude coordinate pairs placed in chronological order according to its time stamps. In one implementation, the location similarity application 60 may extract each latitude and longitude coordinate pair (GPS coordinates) and time stamps of these coordinate pairs from the GPS log of a user. The location similarity application 60 may then represent each pair of latitude and longitude coordinates as a node on a graph or map. The location similarity application 60 may connect each node on the graph with an arrow such that the arrow may be directed from one node to the subsequent node visited by the user. The nodes may also include the time stamps that correspond to the coordinates.

At step 230, the location similarity application 60 may determine the stay points of one or more GPS logs. The stay point may refer to a virtual location that may be in the center of a geographical region where a user may have stayed over a certain time interval. The determination of the stay point may depend on a distance threshold (Dₜₕᵣₑₛₕ) and a time threshold (Tₜₕᵣₑₛₕ). In one implementation, the stay point may be regarded as a virtual location characterized by a group of nodes where the distance between the each node may be less than the distance threshold and the time interval between the first node and the last node in the group may be greater than the time threshold (∀m<i≦n, Distance(pₘ,pᵢ)≦Dₜₕᵣₑₕ and |pₙ.T−pₘ.T|≧Tₜₕᵣₑₕ). In one implementation, the stay point may be generated by finding the average of the latitude coordinates of the group of nodes and the average of the longitude coordinates of the group of nodes. The stay point may then be considered to have the latitude coordinate and the longitude coordinate equal to the average of the latitude coordinates and the average of the longitude coordinates of the group of nodes.

In one implementation, each stay point (Sᵢ) may be described by a set of data including a latitude coordinate, a longitude coordinate, an arrival time, and a departure time, or S=[Latitude coordinate (Lat), Longitude coordinate (Lngt), arrival Time (arv), departure Time (dep)], where

staypoint latitude (Lat)=Σᵢ₌ₘⁿpᵢ·Lat/|P|

staypoint longitude (Lngt)=Σᵢ₌ₘⁿpᵢ·Lngt/|P|

staypoint arrival time (arv)=pₘ·T

staypoint departure time (dep)=pₙ·T

Here, P may represent a collection of GPS points P={p₁, p₂, . . . , pₙ}, and each GPS point pᵢεP may contain a latitude (pᵢ.Lat), a longitude (pᵢ.Lngt) and a timestamp (pᵢ.T).

The stay point arrival and departure times may represent a time that a user arrives at and departs from the stay point. Typically, stay points may be obtained when an individual remains stationary for a time that may exceed the time threshold (e.g., when individual enter a building and lose satellite signal over a time interval until coming back to outdoors) or when a user wanders around within a certain geo-spatial range for a period of time that may exceed the time threshold (e.g., when individual travel outdoors and are attracted by the surrounding environment).

At step 240, the location similarity application 60 may formulate a second location history with the stay points obtained at step 230. The second location history may include a record of stay points that a user may have visited over an interval of time. In one implementation, the second location history may include a sequence of stay points that may have been determined at step 230. The second location history may describe the location and an order in which a user may have visited one or more locations. The second location history (LocH) may be defined as:

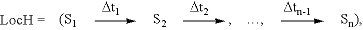

where sᵢεS and Δtᵢ=sᵢ₊₁.arvT−sᵢ.levT where sᵢ may represent a particular stay point and Δtᵢ may represent the amount of time it took for a user to travel from one stay point to the next stay point.

At step 250, the location similarity application 60 may determine one or more clusters for all of the stay points determined at step 230. Each cluster may include one or more stay points that may be densely populated with a geographical area. In one implementation, the location similarity application 60 may collect all of the stay points of each GPS log stored in a memory and provide the collection of stay points to a density-based clustering algorithm to create one or more hierarchal clusters based on the geospatial regions of the stay points in the dataset.

In one implementation, a first cluster may include a maximum number of stay points that may encompass a large geographical area. The first cluster may be part of the highest layer of the hierarchal clusters. The density-based clustering algorithm may further locate one or more subclusters within the first clusters. Each subcluster may include one or more stay points that may be part of the first cluster; however, the stay points that may be part of the subcluster may include stay points that may be more densely populated than the stay points in the first cluster. The density-based clustering algorithm may locate additional subclusters within clusters depending on the proximity of one or more stay points. Each subcluster may represent a layer under the layer where its cluster may lay in the hierarchal clusters. In one implementation, each subcluster may represent a smaller geographical region than the cluster of which it may be part.

At step 260, the location similarity application 60 may formulate a hierarchal framework based on the clusters and subclusters determined at step 250. The hierarchal framework F may be defined as a collection of clusters C (and subclusters) on one or more layers L such that F=(C, L), where L={l₁, l₂ . . . lₙ} denotes the collection of layers of the hierarchy, and C={cᵢⱼ|1≦i≦|L|,0≦j<|Cᵢ|}, where cᵢⱼ represents the jth cluster of stay points S on layer lᵢεL, and Cᵢ is the collection of clusters on layer lᵢ. In one implementation, stay points from various users or GPS logs may be assigned to one or more clusters C on one or more layers L.

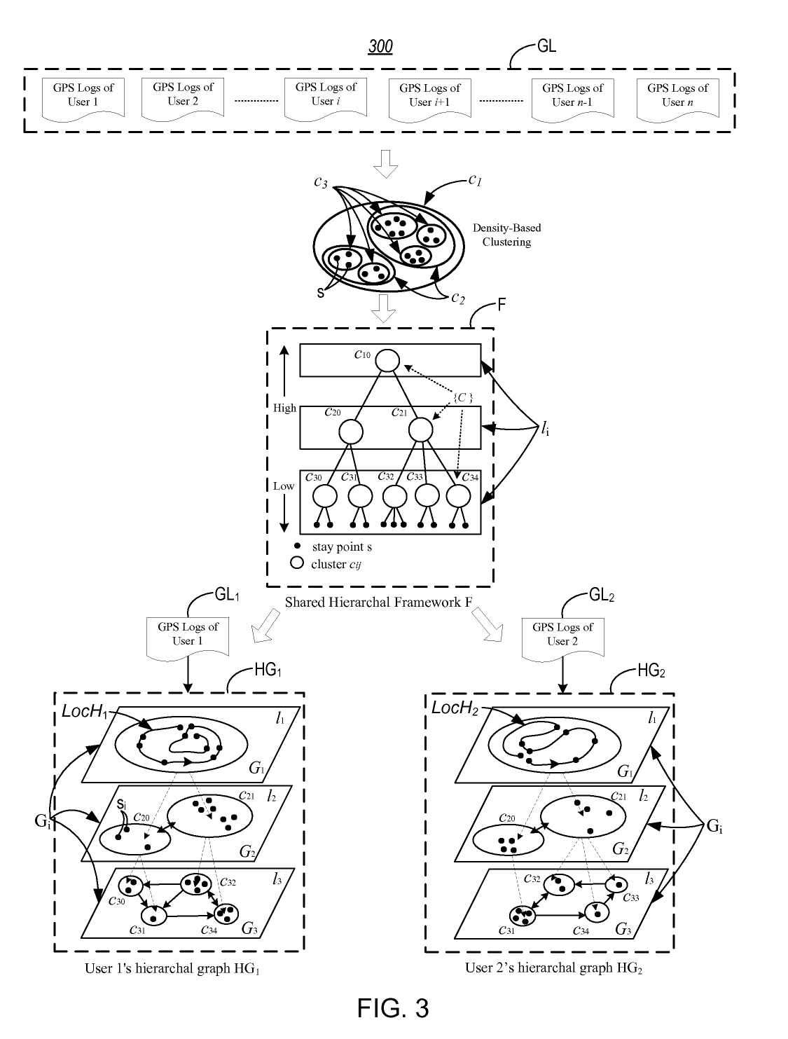

For example, a first cluster of stay points may include one or more sub-clusters within itself. Here, the first cluster may be considered to be on a top (high) layer of the hierarchal framework, and each sub-cluster within the first cluster may be considered to be on the same layer of the shared hierarchal framework which may be one layer below the first cluster's layer on the hierarchal framework. From the top to the bottom of the hierarchal framework, the geospatial scale of clusters decreases while the granularity of geographic regions may increase from being coarse to being fine. The hierarchical feature of this framework may be useful to differentiate people with different degrees of similarities. Therefore, the users who share the similar second location histories on a lower layer of the hierarchal framework may be more correlated than those who share second location histories on a higher layer. An example of the shared hierarchal framework is illustrated in FIG. 3.

At step 270, the location similarity application 60 may construct a personal hierarchal graph (HG) based on the hierarchical framework (F) and the second location history (LocH) of each user. The personal hierarchal graph HG may include one or more graphs describing the clusters or subclusters that a user may have traveled according to the user's second location history. In one implementation, the location similarity application 60 may cross-reference the second location history of a user with each layer of the hierarchal framework. The location similarity application 60 may map each of the user's stay points in the second location history to its respective cluster or subcluster in each layer of the hierarchal framework. A cluster or subcluster may then contain the user's stay points and an edge may connect two clusters or subclusters to represent the sequence in which the user may visit each cluster or subcluster (geographic regions). The personal hierarchal graph may include one or more graphs such that each graph may correspond to a layer of the hierarchal framework. Given a user's second location history and the hierarchal framework, the user's hierarchical graph may be formulated as a set of graphs describing HG={Gᵢ=(Cᵢ, Eᵢ),1<i≦|L|}, where on each layer lᵢεL, GᵢεHG, and a set of vertexes or clusters cᵢ and the edges Eᵢ may be connecting cᵢⱼεCᵢ.

FIG. 3 illustrates a schematic diagram that represents the process 300 for creating a hierarchal graph in accordance with one or more implementations of various techniques described herein. The following description of the process 300 is made with reference to computing system 100 of FIG. 1 and the method 200 of FIG. 2 in accordance with one or more implementations of various techniques described herein. It should be understood that while the process 300 indicates a particular order of execution of the operations, in some implementations, certain portions of the operations might be executed in a different order. Additionally, the process 300 may correspond to some of the steps illustrated in FIG. 2.

In one implementation, the process 300 may include two or more GPS logs GL from two or more users, one or more clusters cᵢⱼ, one or more stay points S, a hierarchal framework F, one or more user hierarchal graphs HG, one or more second location histories, and one or more layers 1. FIG. 3 illustrates an example of a hierarchal framework F and two user hierarchal graphs HG created for two users according to the method 200 described in FIG. 2.

Referring to step 210, the GPS logs GL may include one or more GPS logs GL of one or more users. In one implementation, GPS logs GL may be downloaded from the GPS device 61 and stored in a memory storage device accessible by the computing system 100.

Referring to step 230, the location similarity application 60 may create one or more nodes on a graph to represent the stay points S from the GPS logs GL. The stay points S may be represented by nodes as indicated in FIG. 3. In one implementation, the location similarity application 60 may determine the stay points S for each user's GPS log GL.

Referring to step 250, the location similarity application 60 may determine one or more clusters cᵢⱼ with the use of a density-based clustering algorithm. The location similarity application 60 may indicate a cluster cᵢⱼ on the graph by enclosing one or more stay points S inside a circle. The jth variable in the cluster cᵢⱼ may be numbered to distinguish each different cluster on a certain layer lᵢ of the shared hierarchal framework F, and the ith variable may correspond to the layer lᵢ in which the cluster cᵢⱼ may be placed. Within the cluster cᵢⱼ, the location similarity application 60 may find one or more subclusters c₍ᵢ₊₁₎ⱼ that may include a group of stay points S with a closer proximity to each other than the stay points S of the original cluster cᵢⱼ. Each subcluster c₍ᵢ₊₁₎ⱼ within a cluster cᵢⱼ may indicate a new level or layer lᵢ in the shared hierarchal framework F or the hierarchal graph HG. Each subcluster c₍ᵢ₊₁₎ⱼ may also be considered to be a cluster c₍ᵢ₊₁₎ⱼ if it contains two or more subclusters c₍ᵢ₊₂₎ⱼ within itself. For example, in the process 300, cluster c₁ may represent the largest geographical area (layer lᵢ=1) of the clusters cᵢⱼ because it may encompass all of the stay points S from each GPS log GL. Subcluster c₂ may represent a subcluster (layer lᵢ=2) of the cluster c₁. Cluster c₃ may then represent a subcluster (layer lᵢ=3) of the cluster c₂. Each layer of the cluster cᵢⱼ may represent a step or layer in the shared hierarchal framework F or a separate graph that may be part of the hierarchal graph HG. The layers lᵢ may correspond to the proximity of the stay points S such that layer 1 (c₁) may correspond to a larger geographical region, and the lower layers (levels 2+) may correspond to an increasingly smaller geographical region.

Referring to step 260, the location similarity application 60 may formulate the shared hierarchal framework F by representing clusters cᵢⱼ according to the layer it may correspond to. For example, cluster c₁₀ may correspond to the cluster c₁, clusters c₂₀ and c₂₁ may correspond to the cluster c₂, and clusters c₃₀, c₃₁, c₃₂, c₃₃, and c₃₄ may correspond to the cluster c₃ referred to above. The stay points S may be represented inside each cluster cᵢⱼ on the lowest layer lᵢ of the hierarchal framework F.

Referring to step 270, the location similarity application 60 may formulate the hierarchal graph HG for a specific user. In one implementation, the location similarity application 60 may extract a user's clusters cᵢⱼ and stay points S from the hierarchal framework F according to the user's GPS log GL. Each cluster cᵢⱼ on a different layer lᵢ of the hierarchal framework F may correspond to a different graph Gᵢ.

In one implementation, the location similarity application 60 may determine the second location history LocH from the GPS log GL for a particular user. For example, the second location history LocH₁ for user 1 may be determined by organizing the stay points S of the GPS log GL₁ for user 1 in a chronological order and connecting each stay point with a directed arrow. The hierarchal graph HG₁ may then be determined by mapping the second location history LocH₁ with the clusters cᵢⱼ in the hierarchal framework F that may include the stay points of the second location history LocH₁. The stay points S part of the second location history LocH₁ may be grouped as per the clusters cᵢⱼ listed in the hierarchal framework F. Each layer lᵢ of the hierarchal framework F may correspond to a graph Gᵢ of the hierarchal graph HG.

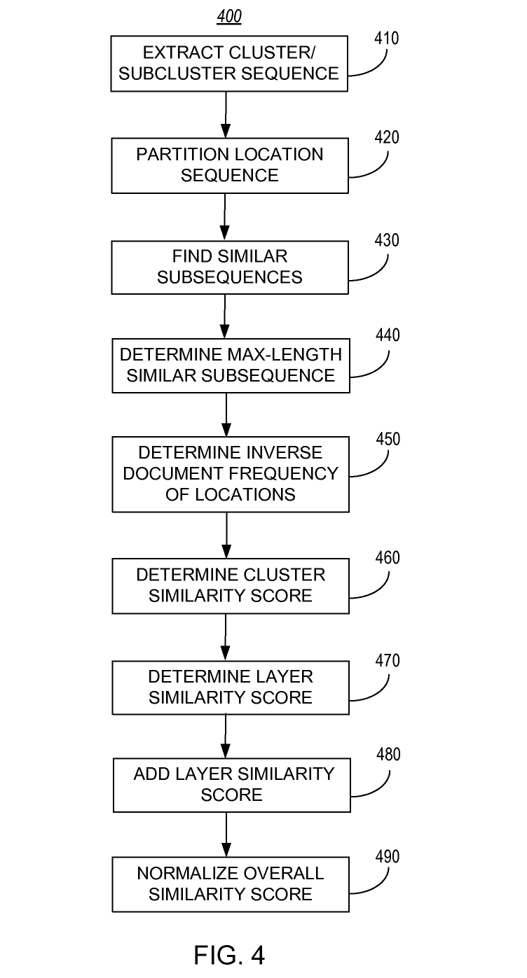

FIG. 4 illustrates a flow diagram of a method 400 for determining user similarities between two users based on location histories in accordance with one or more implementations of various techniques described herein. The following description of method 400 is made with reference to computing system 100 of FIG. 1 and process 300 of FIG. 3 in accordance with one or more implementations of various techniques described herein. Additionally, it should be understood that while the operational flow diagram indicates a particular order of execution of the operations, in some implementations, certain portions of the operations might be executed in a different order. In one implementation, the method for determining user similarities based on location histories may be performed by the location similarity application 60.

At step 410, the location similarity application 60 may extract a sequence of clusters cᵢⱼ or subclusters from each graph in the hierarchal graphs HG of the two users for whom similarities may be determined by the location similarity application 60. In one implementation, the hierarchical graph HG of each user may offer an effective representation of a user's second location history LocH, which may imply a sequence of the user's movement behavior based on geographic spaces of different scales. Given HG₁ and HG₂ of two users (u₁ and u₂) as indicated in FIG. 3, the location similarity application 60 may first locate one or more of the same graph vertexes Vᵢ^{1,2} shared by two users on each layer lᵢεL, where Vᵢ^{1,2}={cᵢⱼ|cᵢⱼεHG₁.Cᵢ∩HG₂.Cᵢ)}, 1≦i≦|L|. Then, on each layer lᵢεL, the location similarity application 60 may formulate a location history sequence for the two users (u₁ and u₂) based on the same graph vertexes Vᵢ^{1,2}. The same graph vertexes Vᵢ^{1,2} may correspond to the clusters cᵢⱼ that the two users may share.

The location similarity application 60 may then obtain the clusters cᵢⱼ that match the same graph vertexes Vᵢ^{1,2} for each graph of each user's hierarchal graph HG. The sequence the clusters cᵢⱼ (and subclusters) may be organized in a chronological order with respect to the all of the clusters cᵢⱼ traveled by each user. The clusters cᵢⱼ may be chronologically organized into a sequence of clusters cᵢⱼ (or subclusters) according to the time stamps of the stay points S within the clusters cᵢⱼ. The location similarity application 60 may then calculate the amount of time elapsed between each chronologically ordered cluster cᵢⱼ pair and store that information within the sequence of clusters cᵢⱼ for each user. For example, the sequence seqᵢ^{k} may denote the sequence of user uₖ on the ith layer of the hierarchal graph HGₖ, the transition time Δtᵢ may denote the time interval between consecutive items of these sequences, and ΔSᵢⱼ may denote the number of stay points S within the cluster cᵢⱼ. An example of the sequence seqᵢ^{k} for users (u₁ and u₂) is listed below:

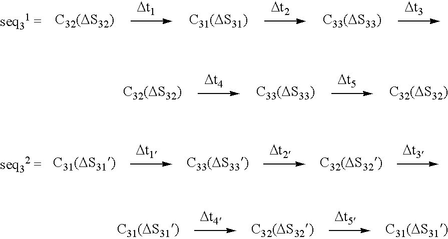

Here, two users' sequences become comparable because the clusters cᵢⱼ may be used rather than stay points S to represent the items of a sequence.

At step 420, the location similarity application 60 may partition the location history sequence obtained at step 410 into several subsequences. In one implementation, location similarity application 60 may partition the sequence because the number of similar sequences with a long length may be difficult to locate, while shorter length subsequences may provide a more efficient medium to locate similarities between two users. In one implementation, if the transition time Δtᵢ between consecutive clusters cᵢⱼ of the sequence seqᵢ^{k} may exceed a certain time period tₚ, e.g., 24 hours, the location similarity application 60 may split the sequence seqᵢ^{k} into two sequences. In one implementation, the location similarity application 60 may continue to partition the original location history sequence of the user multiple times until each shorter length location history sequence does not contain a transition time between consecutive clusters cᵢⱼ above the certain period tₚ.

At step 430, the location similarity application 60 may find one or more similar subsequences between two users with respect to the subsequences partitioned at step 420. In one implementation, the location similarity application 60 may find similar subsequences for one or more users, (uₚ,uₚ₊₁,uₚ₊₂, . . . ) that may have the similar subsequences with similar time intervals. For example, a pair of subsequences seqᵢ^{p} and seqᵢ^{q} may include:

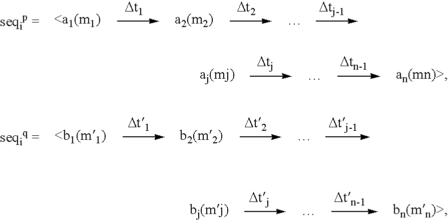

where aⱼεVᵢ^{pq} is a cluster cᵢⱼ, Vᵢ^{pq}={cᵢⱼ|cᵢⱼεHG^{p}.Cᵢ∩HG^{q}.Cᵢ)},1≦i≦|L| is the graph vertexes shared by uₚ and u_{q} on layer lᵢ, mᵢ represents the times the user successively visits cluster aⱼ, and Δtⱼ stands for the transition time the user traveled from cluster aⱼ to aⱼ₊₁. The location similarity application 60 may determine that sub sequences seqᵢ^{p} and seqᵢ^{q} are similar, if and only if they satisfy the following conditions:
1. ∀1≦j≦n, aⱼ=bⱼ, i.e., the nodes at the same position of the two sequences share the same cluster ID;

$$∀ 1 \leq j < n , \frac{\vert Δ {t}_{j} - Δ {t}_{j}^{′} \vert}{max ( Δ {t}_{j} , Δ {t}_{j}^{′} )} \leq p ,$$

2. where p is a pre-defined ratio threshold, which may be referred to as temporal constraint. It denotes that the two users have similar transition times between same regions.
   If both conditions are true, a similar subsequence sseqᵢ^{p,q} contained in the subsequence seqᵢ^{p} and the subsequence seqᵢ^{p} may be retrieved as listed below:

sseqᵢ^{p,q}=<a₁(min(m₁,m₁′))→a₂(min(m₂,m₂′))→ . . . aₙ(min(mₙ,mₙ′))>,

where min(m₁,m₁′) may denote the minimal value between m₁ and m₁′.

At step 440, the location similarity application 60 may identify the similar subsequence sseq of the two users having a maximum number of clusters cᵢⱼ or subclusters in common. The similar subsequence sseq of the two users having a maximum number of clusters cᵢⱼ or subclusters in common may be referred to as the maximum-length similar subsequence. In one implementation, the location similarity application 60 may employ two operations to determine the maximum-length similar subsequence, subsequence extension and subsequence pruning, in determining the maximum number of clusters cᵢⱼ or subclusters that two users may have in common in two subsequences. In one implementation, the location similarity application 60 may first identify one or more subsequences or the two users that may include two clusters or subclusters (1-length similar subsequence) traveled by each user in the same chronological order. In the extension operation, the location similarity application 60 may then extend each m-length similar subsequence to a (m+1)-length similar subsequence. Subsequently, in the pruning operation, the location similarity application 60 may select the maximum-length similar subsequence from the candidates generated by the extension operation, and remove the other similar subsequences from a list of potential maximum-length similar subsequences. The extension and pruning operations may be implemented alternatively and iteratively until each cluster cᵢⱼ in the subsequence is scanned.

For example, the location similarity application 60 may begin by finding a 1-length similar subsequence from all of the partitioned subsequences obtained at step 420. The 1-length similar subsequence may include two clusters cᵢⱼ visited successively by the two users (u₁ and u₂). Upon locating one or more 1-length similar subsequences, the location similarity application 60 may add the 1-length similar subsequences to a list of potential maximal-length similar subsequence. Using the located 1-length similar subsequences, the location similarity application 60 may then compare an additional length of the located 1-length similar subsequences to determine if a 2-length similar subsequence may exist within the set of 1-length similar subsequences (extension operation). If any 2-length similar subsequences are found within the original 1-length similar subsequence, the location similarity application 60 may remove the 1-length similar subsequences (pruning operation) from its list of potential maximal-length similar subsequence and add the similar 2-length similar subsequence to the list. The location similarity application 60 may then continue to perform the extension and pruning operations alternatively and iteratively until the maximal-length similar subsequence is identified.

At step 450, the location similarity application 60 may determine the popularity of a stay point S or cluster cᵢⱼ. In one implementation, the location similarity application 60 may utilize an inverse document frequency (IDF) methodology to quantify the popularity of each geospatial region (stay point S or cluster cᵢⱼ) contained in the similar subsequence. The IDF of a cluster cᵢⱼ may be defined as

$${IDF}_{ij} = \frac{\vert U \vert}{{n}_{ij}} ,$$

where nᵢⱼ defines the number of users that may have visited the cluster cᵢⱼ and U defines the total number of users in the network. In order to use the IDF method, the location similarity application 60 may regard each cluster cᵢⱼ as a document, and the users that may have visited each cluster cᵢⱼ may represent important terms in the document. If the number of users (nᵢⱼ) that may have visited a region (cluster cᵢⱼ) is very large, the

$${IDF}_{ij} = log \frac{\vert U \vert}{{n}_{ij}}$$

of this region would become very small. The IDF value for each location may be used to evaluate the importance or weight of a particular cluster cᵢⱼ.

For example, many users may visit the cluster cᵢⱼ that may include The Great Wall of China. However, a visit to The Great Wall of China may not provide relevant data pertaining to the location similarities between two users because The Great Wall of China is a very popular location that many users with a variety of location histories or interests may visit. The reputation of The Great Wall of China may attract a variety of users; therefore, this region may not offer much valuable information pertaining to the similarity score of these two users. However, if two users share a location history that may include one or more locations that may not be well-known or that may not be accessed by very many users, the two users may share more similar interests.

At step 460, the location similarity application 60 may determine a cluster similarity score ss_{q} for each cluster cᵢⱼ that may be part of a similar location subsequence sseq of two or more users. The cluster similarity score ss_{q} for each cluster cᵢⱼ may include a multiplication of two parts (IDFᵢⱼ×min (mₚ,m_{q})), where the (min (mₚ,m_{q})) may represent the times that two users may have successively accessed the clusters cᵢⱼ in the similar location subsequences. In addition, a length-dependent factor β may be used to distinguish the significance of similar subsequences with various lengths, len, such that the β=2^{len-1}. In other words, the longer the similar location subsequence matched between two users' location histories, the more related these two users might be; hence, a higher weight or high score may be awarded to this similar subsequence.

At step 470, the location similarity application 60 may determine a layer similarity score ssₗ for each subsequence on a specific layer for each similar subsequence sseq on the layer l. The layer similarity score ss, of the two users on the layer may include the sum of the cluster similarity scores ss_{q} on the specific layer. In one implementation, a layer-dependent factor a may be used to weigh the significance of similar subsequences found on different layers. For instance, the location similarity application 60 may use α=2ⁱ⁻¹. In other words, people who share a subsequence of places on a lower layer (with finer granularity) might be more related than others who share a subsequence of places on a higher layer (with coarse granularity).

At step 480, the location similarity application 60 may then add the layer similarity scores ssₗ of each layer on the personal hierarchal graph HG to determine the overall similarity score ss^{p,q} the users.

At step 490, the location similarity application 60 may then normalize the calculated overall similarity score SSpq to provide a fair result to the users with various scales of GPS logs. In one implementation, the location similarity application 60 may divide the overall similarity score ss^{p,q} by the multiplication of the scales of their dataset (|S^{p}|×|S^{p}|). In a new network of users, some users may have more GPS logs provided to the application than others. The location similarity application 60 may be more likely to find similar locations visited by two users who may have provided many GPS logs than those who provided fewer GPS logs given the quantity of GPS information provided. It may be more likely for two users to have visited more similar locations given more locations listed in each GPS log; however, the increased likelihood of similar locations between two users may not accurately reflect the actual similarities between two users. Normalizing the data may allow for each user to be evaluated equally even if some users provide more GPS logs than other users. If the location similarity application 60 does not normalize the data, the users with more GPS logs supplied to the location similarity application 60 may continuously be recommended to others even though they may not be the most perfect candidates.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for determining similarities between a first user and a second user in a network, comprising:
receiving one or more Global Positioning System (GPS) logs from each user in the network;
constructing a first hierarchal graph for the first user's GPS log and a second hierarchical graph for the second user's GPS log; and
calculating a similarity score between the first user and the second user based on the first hierarchal graph and the second hierarchical graph.

2. The method of claim 1, wherein constructing the first hierarchal graph and the second hierarchical graph comprises:
consolidating information of the GPS logs into a hierarchal framework;
creating the first hierarchical graph for the first user's GPS log based on the hierarchal framework; and
creating the second hierarchical graph for the second user's GPS log based on the hierarchal framework.

3. The method of claim 2, wherein consolidating the information of the GPS logs comprises:
formulating a first location history describing one more locations traveled by each user in a chronological order based on each user's GPS log;
determining one or more stay points along each first location history;
grouping the stay points into one or more clusters;
grouping the stay points in the clusters into one or more subclusters; and
mapping the clusters into one or more higher layers of the hierarchal framework; and
mapping the subclusters into one or more lower layers of the hierarchical framework.

4. The method of claim 3, wherein determining the stay points comprises:
identifying a portion of the one or more locations that are within a predetermined distance threshold, wherein a time interval between a first location and a last location in the portion exceeds a predetermined time threshold;
extracting a latitude coordinate and a longitude coordinate for each identified location;
calculating an average of the latitude coordinates and the longitude coordinates of the portion of the locations; and
creating a stay point at the average of the latitude coordinates and the longitude coordinates.

5. The method of claim 3, wherein the stay points are grouped into the clusters and the subclusters using a density-based clustering algorithm.

6. The method of claim 3, wherein creating the first hierarchical graph comprises:
formulating a second location history describing the stay points traveled by the first user in a chronological order based on the first user's GPS log;
mapping the stay points of the second location history to the clusters or subclusters in each layer of the hierarchical framework; and
creating a graph for each layer of the hierarchical framework, wherein the graph describes the clusters or subclusters traveled by the first user.

7. The method of claim 3, wherein creating the second hierarchical graph comprises:
formulating a third location history describing the stay points traveled by the second user in a chronological order based on the second user's GPS log;
mapping the stay points of the third location history to the clusters or subclusters in each layer of the hierarchical framework; and
creating a graph for each layer of the hierarchical framework, wherein the graph describes the clusters or subclusters traveled by the second user.

8. The method of claim 3, wherein calculating the similarity score between the first user and the second user comprises:
extracting a sequence of clusters or subclusters traveled by the first user and the second user from one or more graphs in the first hierarchical graph and the second hierarchical graph, wherein each graph in the first hierarchical graph describes the clusters or subclusters traveled by the first user and each graph in the second hierarchical graph describes the clusters or subclusters traveled by the second user;
partitioning each sequence into one or more subsequences;
identifying a subsequence traveled by the first user and the second user having a maximum number of clusters or subclusters in common;
quantifying a popularity of each cluster or subcluster in the subsequence using an inverse document frequency methodology, wherein the inverse document frequency of the clusters or subclusters in common is defined as
$${IDF}_{ij} = log \frac{\vert U \vert}{{n}_{ij}} ,$$
where nᵢⱼ defines a total number of users in the network that visited the clusters or subclusters in common and U defines the total number of users in the network;
determining a similarity score ss_{q} for each cluster or subcluster in common, wherein the similarity score ss_{q} equals to IDFᵢⱼ×min (mₚ,m_{q}), and where the min (mₚ,m_{q}) represents one or more times that the first user and the second user successively accessed the clusters or subclusters in common;
adding the similarity scores for each cluster or subcluster in common; and
normalizing the sum.

9. The method of claim 8, wherein the maximum number of clusters or subclusters in common are in a same chronological order.

10. The method of claim 8, wherein a travel time between each cluster or subcluster in the maximum number of clusters or subclusters in common is substantially similar.

11. The method of claim 8, wherein partitioning each sequence comprises:
determining whether an amount of time between two consecutive clusters or subclusters in the sequence exceeds a time value; and
partitioning the sequence into subsequences where the two consecutive clusters or subclusters exceeds the time value.

12. The method of claim 8, wherein calculating the similarity score between the first user and the second user further comprises:
assigning a weight to the similarity score of each cluster or subcluster in common based on the maximum number of clusters or clusters in common.

13. The method of claim 8, wherein calculating the similarity score between the first user and the second user further comprises:
assigning a weight to the similarity score of each cluster or subcluster in common based on a layer in which the maximum number of clusters or clusters in common are located on the hierarchal framework.

14. A computer system, comprising:
a processor; and
a memory comprising program instructions executable by the processor to:
receive one or more Global Positioning System (GPS) logs from two or more users in the network;
consolidate information of the GPS logs into a hierarchal framework;
create a first hierarchical graph for the first user's GPS log based on the hierarchal framework;
create a second hierarchical graph for the second user's GPS log based on the hierarchal framework; and
calculate a similarity score between the first user and the second user based on the first hierarchal graph and the second hierarchical graph.

15. The computer system of claim 14, wherein the program instructions executable by the processor to consolidate information of the GPS logs into the hierarchal framework comprise program instructions executable by the processor to:
formulate a first location history describing one or more locations traveled by each user in a chronological order based on each user's GPS log;
determine one or more stay points along each first location history;
group the stay points into one or more clusters;
group the stay points in the clusters into one or more subclusters; and
map the clusters into one or more higher layers of the hierarchal framework; and
map the subclusters into one or more lower layers of the hierarchical framework.

16. The computer system of claim 15, wherein the program instructions executable by the processor to determine the stay points comprise program instructions executable by the processor to:
identify a portion of the one or more locations that are within a predetermined distance threshold, wherein a time interval between a first location and a last location in the portion exceeds a predetermined time threshold;
extract a latitude coordinate and a longitude coordinate for each identified location;
calculate an average of the latitude coordinates and the longitude coordinates of the portion of the locations; and
create a stay point at the average of the latitude coordinates and the longitude coordinates.

17. The computer system of claim 15, wherein the stay points are grouped into the clusters and the subclusters using a density-based clustering algorithm.

18. A computer-readable medium having stored thereon computer-executable instructions which, when executed by a computer, cause the computer to:
receive one or more Global Positioning System (GPS) logs from two or more users in the network;
formulate a first location history describing one or more locations traveled by each user in a chronological order based on each user's GPS log;
determine one or more stay points along each first location history;
group the stay points into one or more clusters;
group the stay points in the clusters into one or more subclusters; and
map the clusters into one or more higher layers of a hierarchal framework;
map the subclusters into one or more lower layers of the hierarchical framework;
create a first hierarchical graph for the first user's GPS log based on the hierarchal framework;
create a second hierarchical graph for the second user's GPS log based on the hierarchal framework; and
calculate a similarity score between the first user and the second user based on the first hierarchal graph and the second hierarchical graph.

19. The computer-readable medium of claim 18, wherein the computer-executable instructions to calculate the similarity score between the first user and the second user are configured to:
extract a sequence of clusters or subclusters traveled by the first user and the second user from one or more graphs in the first hierarchical graph and the second hierarchical graph, wherein each graph in the first hierarchical graph describes the clusters or subclusters traveled by the first user and each graph in the second hierarchical graph describes the clusters or subclusters traveled by the second user;
partition each sequence into one or more subsequences;
identify a subsequence traveled by the first user and the second user having a maximum number of clusters or subclusters in common;
quantify a popularity of each cluster or subcluster in the subsequence using an inverse document frequency methodology, wherein the inverse document frequency of the clusters or subclusters in common is defined as
$${IDF}_{ij} = log \frac{\vert U \vert}{{n}_{ij}} ,$$
where nᵢⱼ defines a total number of users in the network that visited the clusters or subclusters in common and U defines the total number of users in the network;
determine a similarity score ss_{q} for each cluster or subcluster in common, wherein the similarity score ss_{q} equals to IDFᵢⱼ×min (mₚ,m_{q}), and where the min (mₚ,m_{q}) represents one or more times that the first user and the second user successively accessed the clusters or subclusters in common;
add the similarity score for each cluster or subcluster in common; and
normalize the sum.

20. The computer-readable medium of claim 18, wherein the stay points are grouped into the clusters and the subclusters using a density-based clustering algorithm.
